(19) United States
(12) Patent Application Publication
(10) Pub. No.: US 2002/0073270 A1
(43) Pub. Date: Jun. 13, 2002

(54) Headerless split sector format for optical disk drives

(76) Inventor: William E. Benson, San Mateo, CA (US)

Correspondence Address: Bradley J. Bereznak, Blakely, Sokoloff, Taylor & Zafman LLP, Seventh Floor, 12400 Wilshire Boulevard, Los Angeles, CA, 90025-1030, US

(21) Appl. No.: 09/733,583

(22) Filed: Dec. 7, 2000

(51) Int. Cl. G06F 13/00

(52) U.S. Cl. 711/102

(57) ABSTRACT

The present invention describes a system for managing data on a magneto-optical data storage disks, which improves the storage capacity of the disk. The system is able to locate data sectors without requiring the sectors to be accompanied by an identification field. The data in the sector may be contiguous, or may be split between adjacent data wedges, such that successive wedges each contain a partial segment of the sector. The location and attributes of the sectors and split sectors are obtained by reference to a data sector information table residing in random-access memory, and derived from format information previously recorded on the disk or in other non-volatile memory.

### FIELD OF THE INVENTION

This invention relates to magneto-optical disk drives. More particularly, this invention relates to formatting of data on magneto-optical storage disks.

### BACKGROUND OF THE INVENTION

Magneto-optical (MO) disk drives record data by locally heating a small spot on the magneto-optical disk with focused laser light, while a magnetic field is applied perpendicular to the heated area. The disk drive reads the data from the media with a linearly polarized light beam, whose intensity is much less than the intensity used to heat the media during the write process. The interaction of the polarized light with the magnetized spot causes a rotation of the polarization known as the Kerr effect. The rotation of the light is detected, thereby revealing the up- or down-orientation of the magnetic bit. Depending on the details of the encoding algorithm, the user data is retrieved by interpretation of the bit patterns, or flux reversals, or more specifically by the intervals between flux reversals.

User data is organized into blocks of fixed size, and placed on the MO disk at specific radial and circumferential coordinates. The mapping of these locations, that is the relationship between physical position of the data and the logical address of the data, is the task of the format electronics, operating under a set of rules known collectively as a format. In response to a request from the host interface, the format electronics determines the physical location of the requested block, and instructs servo electronics as to what physical address to actuate the read/write apparatus.

The first coordinate of the physical address of a block of data is the “track number”. The data is stored in a set of annular rings, called tracks, the tracks occurring at specific radii from the inner diameter (ID) to the outer diameter (OD). In most magneto-optical drives, the tracks are physical grooves pre-embossed in the plastic disk substrate by the disk manufacturer. The grooves are formed at a precise pitch, so that they are separated by lateral extents of higher elevation called lands. Data sectors are then placed circumferentially around the track, recorded in the lands or grooves or both. The data is written in sequences of fixed-length blocks called sectors, so that a plurality of sectors is stored circumferentially around a given track.

Having located the correct track, servo electronics applies the second coordinate of the physical address, the “sector number”, to locate the target sector. The sector number is written on the disk in a preamble identification (ID) field which introduces each sector. As the disk spins, the read/write apparatus reads each sector ID field passing underneath it and decodes the sector number. When the target number is reached, the read/write apparatus is confirmed to be at the correct track and sector, and proceeds with the requested operation on that sector.

Sector identification fields therefore precede each and every sector on the disk. The sector identification fields contain not only the encoded sector number, but also the track number for verification, the head number (for drives with a plurality of heads), an address mark, one or more clock synchronization fields, on or more gaps or pads for timing purposes, error correction bits or bytes, and other pieces of administration data. In total, the sector identification field can be hundreds of bytes in length, to introduce each 512-byte sector.

The requirement for lengthy sector administration fields implies that a substantial fraction of the available disk surface area is devoted to providing format, timing, or other maintenance information. These information fields are known generally as “overhead”, in that a portion of the available area is used for directing the drive's operations rather than for customer data. Overhead presently comprises up to 40% of the total available space, leaving only 60% for customer data. For example the current ISO standard for 5.2 GB MO cartridge, with 512 byte sector formatting, dedicates 38% of the disk surface area to overhead.

As performance, capacity and cost requirements become more demanding, disk overhead becomes increasingly burdensome. A number of advancements have been made in the fixed-disk magnetic drives to reduce overhead. Fixed-disk drives use purely magnetic effects to read and write data, and the data storage disk is resident in the drive enclosure. Tracking of the data head over a data tracking is accomplished by decoding bursts of servo information written at regular intervals on the disk. Techniques such as those found in U.S. Pat. Nos. 5,768,044 and 5,210,660, generate timing pulses to locate the data sectors relative to the servo bursts. The algorithms also allow for the data sectors to be split by servo bursts, thereby further improving format efficiency. Although these approaches are useful for fixed-disk drives, they have generally been dismissed as impractical for use in MO drives because they require servo bursts for implementation, and modern MO drives do not utilize servo bursts. As a result, MO drives remain burdened by high overhead surface formats to locate and identify data sectors.

### BRIEF DESCRIPTION OF THE DRAWINGS

FIGS. 1a through 1c are simplified illustrations of a disk surface layout, with increasing detail of the structure of an exemplary track and wedge.

FIG. 2 is a simplified flow diagram according to this invention.

FIG. 3 shows a sample output of the format electronics, operating under this invention.

### DETAILED DESCRIPTION

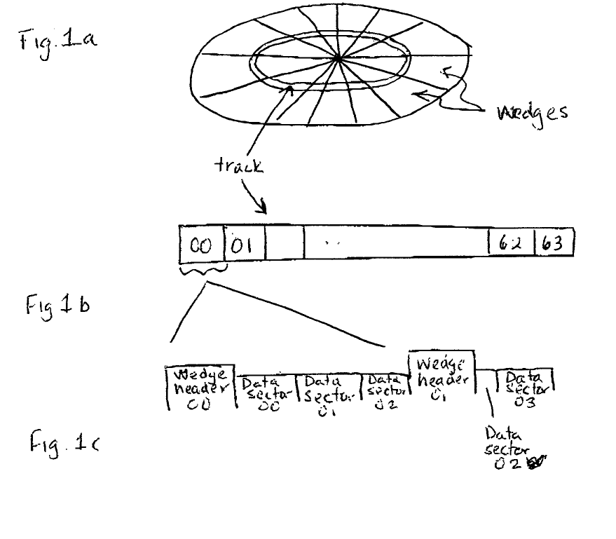

FIG. 1a shows a simplified diagram of the data layout on the surface of a disk, according to this invention. The surface of the disk is divided into a plurality wedges of identical arc lengths around the circumference of the track. In the embodiment described herein, there are 64 wedges in a 360 degree revolution.

The data on the disk is arranged in a set of tracks which may be concentric rings or a contiguous spiral pattern, and formed by embossing the grooves into the plastic substrate by the disk manufacturer. Data is recorded on both the lands and the grooves in this implementation. A single contiguous land/groove pair form a double spiral, spiraling inward from the outer diameter to the inner diameter at the designated track pitch, when the disk rotates counterclockwise as viewed from the optical transducer.

Each track is divided into 64 subsections, corresponding to the 64 wedges defined on the disk surface. For convenience these subsections are also called wedges, although they are only one track wide. An exemplary 64-wedge track is shown in FIG. 1b. The user data is organized into fixed block sectors, and these blocks are placed within the wedges on each data track.

The wedges are introduced by an information field called a wedge header, which identifies the track number on which the wedge resides, and the circumferential position of the wedge, in terms of a “wedge number”. Wedge numbers fall between #00, for the first wedge beginning a revolution, to #63, the last wedge in the revolution. Each data track has an identical number of wedges and wedges headers, which are registered one-to-another from one track to the next. Therefore when viewing the disk surface from above, the wedge headers occur at the same angular position in every data track, so that the wedge headers appear as a set of spokes radiating from ID to OD.

The wedge headers also may be pre-embossed by the media manufacturer, or written by the drive, and may comply with the format requirements for the capacity design point. The wedge headers may also contain a number of administration fields such a synchronization patterns, error detection or correction, and pad fields. The wedge header is protected by bits of cyclical redundancy code (CRC), which detect the presence of an error in the wedge header.

Wedges provide subdivisions of a track which help to locate particular data sectors stored circumferentially within the wedges. Each wedge contains between 1 and 4 data sectors for this embodiment, but other choices are possible and depend on the details of the application. According to this invention, the data sectors within the wedge are not accompanied by identification fields; they are headerless.

The data recording tracks are further grouped into annular zones, each zone including a number of tracks. Within each zone the data rate is constant for all tracks, but the data rate rises from zone-to-zone from ID to OD. This enables more efficient use of the larger circumference tracks at the OD compared to the ID, by keeping the linear density approximately constant across the disk. Since the linear velocity is higher at the OD compared to the ID, the data rate is higher for the OD zones.

Since the data rate changes from zone-to-zone, the parameters input to the signal processing channel must change depending on which zone is being accessed. For example the equalizer gain, boost and cutoff frequency must be adjusted in each zone to match the data rate. The channel parameters, beginning and ending track number, and data rate for each zone constitute a zone table, which is stored on the disk in a reserved area, or may be stored in non-volatile semiconductor memory in the drive electronics. The zone table may be specific to a generation of disk surface format, or may be unique to the individual disk itself.

The invention makes use of the zone table to calculate the exact starting location of every sector on the disk. This is possible because the data frequency for each zone is known, the total number of bytes per track is known, and the length of each fixed-block sector is known. Therefore, the location of each sector, in terms of data clock counts (also known as NRZ counts, where NRZ refers to the encoding algorithm) can be computed from a single starting point, as illustrated in FIG. 1c. The values computed for the start of each data sector are stored in a data sector information table, and indicate to the controlling electronics how many clock counts from a reference point is the start of the requested data sector.

The reference point can be any unique mark; in this embodiment the timing data in the data sector information table refer to the wedge header as a starting point. The data sector information table need only refer to a single exemplary track in each zone, as all tracks within the zone are identical, and the track number is stored in every wedge header.

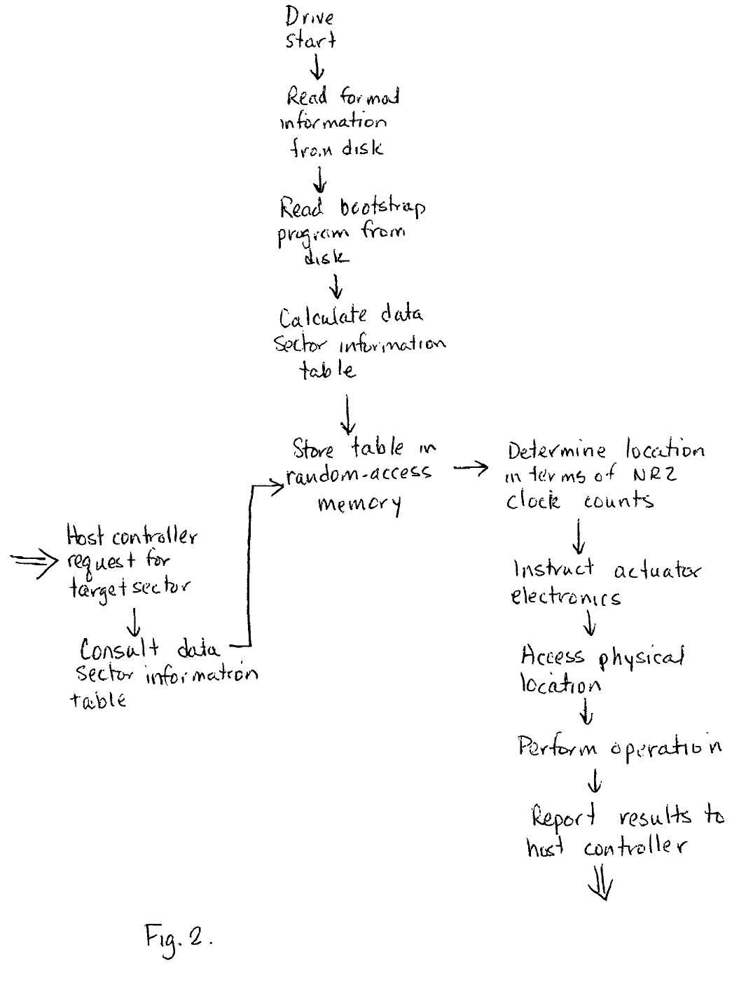

A minimal set of instructions for generating the data sector information table is stored in a reserved area of the disk, or in non-volatile memory. This algorithm is executed upon drive startup, which calculates the values and stores them in random-access or other fast memory. This “bootstrap” method is appropriate for situations in which a relatively small amount of non-volatile memory is available for storing parameters and starting instructions. In the embodiment discussed here, only the zone table, format information and the bootstrap algorithm need to be permanently resident. The bootstrap algorithm also computes checksum or CRC bits and appends them to the table, so that the integrity of the table can be continuously verified. A generalized flow diagram of the startup procedure and subsequent operation of the drive, in accordance with this invention, is shown in FIG. 2.

It should be clear to one skilled in the art that other tradeoffs can be made depending on the details of the application, the availability of memory, and the speed of the processor. For example, rather than storing the values in a data sector information table, they could also be calculated on-the-fly as needed, in response to a given request for a target sector, is processor time is available. On the other extreme, the entire data sector information table could be stored permanently, if performance requires it.

As described above, wedge headers constitute the timing marks from which the locations of the data sectors are determined. Any unique mark can be selected, however tolerances need to be considered when choosing the number and locations of timing references. For example, it is possible to implement this invention using a single, once-around index mark as a timing reference from which to locate a given sector. However factors such as spindle speed variation, clock drift and jitter, begin to accumulate into a substantial error over a complete revolution of the disk. If this error is compensated for by the addition of gaps or pad fields, then the improvement in overhead may be compromised.

Split sectors are also enabled by this invention. Split sectors occur when the distance between wedge headers is such that a non-integer number of data sectors can fit in the wedge. In order to make efficient use of available space, the last sector will be divided, or split, between wedges with the leading portion falling in the present wedge and the remaining portion following the next wedge header. In this case, the 512-byte data sector straddles a wedge header. This case is exemplified in FIG. 1c, in which wedge #00 contains two complete data sectors and a partial sector. The location of the split sectors is calculated by the bootstrap algorithm according to the zone table and format, in analogy to the handling of unsplit sectors.

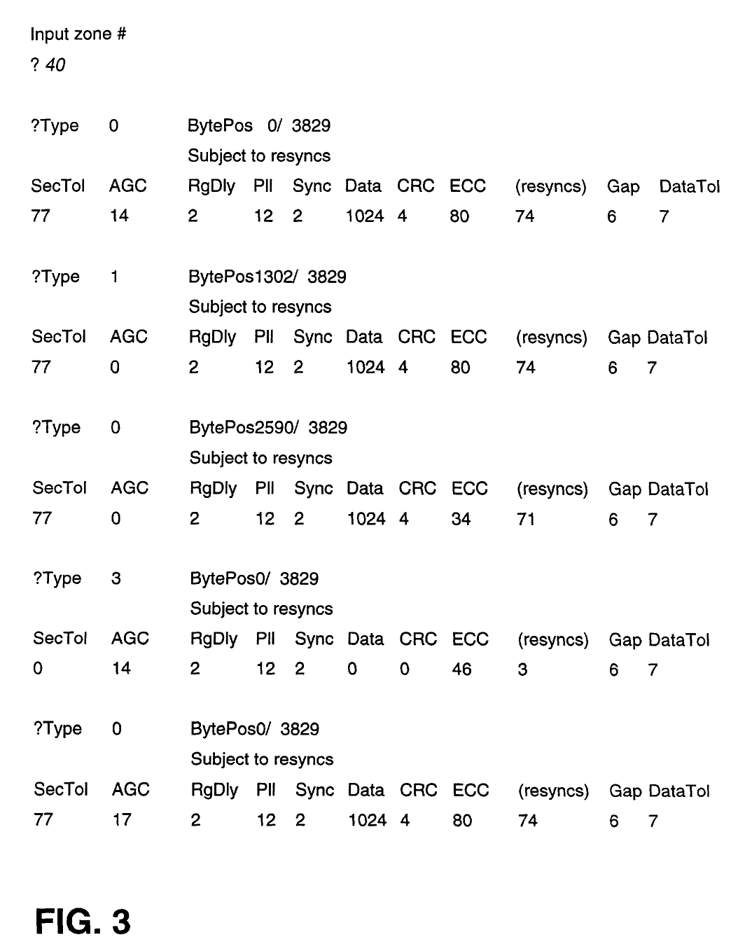

A sample output of the format electronics operating by reference to the stored data sector information table is shown in FIG. 3. In response to the series of requests listed, format electronics retrieves the exact composition of the requested data portions. Specifically, the system identifies data sector 2 in wedge 0 as being a split sector, split by a wedge header of wedge 1, at byte 34 of its ECC field. The remaining 46 bytes are found in the following wedge, wedge 1.

The construction of the data sector information table is flexible, programmable, and therefore allows any number of physical data layouts and capacities to exist within the pre-embossed format. By virtue of this flexible architecture, multiple versions of zoning, capacity and data layout can reside on a pre-embossed MO disk, without violating the format requirements or upgrading the hardware or firmware of the drive. The bootstrap algorithm would be essentially identical for multiple species of data capacities, but within a single pre-embossed format standard.

It should be noted that the choice of the sector configuration is flexible. For example, the entire track could be defined as a single sector. The track would therefore comprise a single 360-degree “wedge”, which further comprises a single 360-degree sector. Conversely, a sector may be defined to be longer than a wedge, such that virtually all wedges comprise split sectors. Lastly, although the industry-standard block size is a multiple of 512 bytes, such as 1024 or 2048 bytes, this invention can accommodate any arbitrary block size as long as the block size can by known by the drive and startup algorithm, and the disk is correctly formatted for that block size.

In yet a further embodiment, the split sector does contain an information field, indicating that the sector is interrupted by a wedge header. The distinction is that this information may be recorded on an information field, rather than computed according to format parameters. This embodiment may be preferable when computation time or memory space is limited, and the increase in storage area overhead is tolerable. The information field may include, but is not limited to or required to include, the number of bytes in a first split sector segment that follows a wedge header, the number of full data sectors that fit between the first wedge header and the adjacent second wedge header, and the number of bytes in a second split sector segment that precedes the second wedge header. Any of the three pieces of split data sector information that are not included in the split data sector information field can be calculated from the split data sector information that is available from the split data sector information field. Whether this approach is advantageous depends on the details of the application, as penalties may accrue from delays of the encoder/decoder and read channel recovery time, and switching time between the read and the write function.

In another embodiment, any one of the above identified split data sector information fields, or any sub-fields therein, can be accompanied by its own ECC field or other error detection and correction field for data integrity verification. In the embodiment described above, the information table is located in the buffer memory and protected by cyclical redundancy code (CRC) information appended to the table there. Optionally, more powerful error detection or error correction techniques may be applied to protect the integrity of the data sector information table. The data sector information table or table parameters can also be protected by storing multiple copies in the reserved area of the disk

In another embodiment, the amount of information included in the data sector information can be further minimized to contain only the first location of a split sector. The number of fixed length full data sectors and the number of remaining bytes between adjacent wedge headers can be quickly calculated because the distance between adjacent wedge headers is a known constant and the read/write frequency for a given track is known. Penalties may accumulate in this embodiment because of variation in linear velocity from spindle speed variations or other sources of timing drift or jitter.

In another embodiment, the amount of information included in the data sector information table can be minimized to contain only the location of the last segment of a split sector. The number of fixed length full data sectors and the number of remaining bytes between adjacent wedge headers can be quickly calculated as previously stated, and commensurate penalties accrued.

In another embodiment, the information in a data sector information table can be configured to contain overlapping or look-ahead data sector information. For example, a split data sector information table can include data for a first data sector between a first wedge header and an adjacent second wedge header, and similar information relating to the data sectors between the second wedge header and an adjacent third wedge header. The number of fixed length full data sectors and the number of remaining bytes between adjacent wedge headers can quickly be calculated as previously disclosed.

It is further apparent that while the embodiments have been described in the context of a zone recording format, the invention may be applied to other complex formats where the number of data sectors on a track is not equal to the number of data wedges on a track, so long as the format details are known to the disk drive.

Any non-volatile medium may be used to store the table parameters and/or the data sector information table itself, although for this embodiment the table parameters are stored on the disk. The use of modifiable storage (i.e., the disk) allows the disk drive to alter its own operation to accommodate disks of various different formats and capacities, without need for external intervention, based on format information written on the disk itself. This invention also allows the drive the to accept new and potentially improved formats, without necessarily establishing new industry standards or changing the pre-embossed format of the disk. A drive equipped per this invention can also handle disks of variable capacity, without necessarily changing the hardware or firmware installed on the drive, as long as the disk contains information allowing the drive to identify the format.

While the invention has been particularly described and illustrated with reference to a particular embodiment, it will be understood by those skilled in the art that changes in the description and illustrations may be made with respect to form and detail without departing from the spirit and scope of the invention. Accordingly, the present invention is to be considered as encompassing all modifications and variations coming within the scope defined by the following claims.

I claim:

1. A magneto-optical disk having a surface to store data magneto-optically, the surface having a format comprising:
one or more data tracks on said surface, each data track being divided into one or more data wedges, each data wedge further comprising:
at least one headerless data sector, and
a wedge header information field.

2. The magneto-optical disk of claim 1, wherein the data tracks comprise a spiral pattern.

3. The magneto-optical disk of claim 1, wherein the data tracks comprise a double spiral pattern.

4. The magneto-optical disk of claim 1, wherein at least one of the data wedges comprises a non-integral number of headerless data sectors.

5. The magneto-optical disk of claim 1, wherein the headerless data sectors are of fixed length.

6. The magneto-optical disk of claim 1, wherein the headerless data sectors have variable length.

7. The magneto-optical disk of claim 1, wherein at least one of the data wedges comprises an integral number of headerless data sectors.

8. A data management system for a magneto-optical data storage disk drive, said management system comprising:
a magneto-optical disk having a surface for storing data magneto-optically, the surface having a format comprising:
one or more data tracks on said surface, each data track being divided into one or more data wedges, each data wedge further comprising:
at least one headerless data sector, and
a wedge header information field;
a data storage device to store a data sector information table that includes data sector locations, and
circuitry to transfer data sector information from the data sector information table to random-access memory, the random-access memory being accessed during a target sector search.

9. The system according to claim 8, wherein said data sector information table includes one or more split data sector locations.

10. The system according to claim 8, wherein said data sector information table includes error correction information for said data sector information table.

11. The system according to claim 8, wherein said data sector information table includes error detection information for said data sector information table.

12. The system according to claim 8, wherein said data sector information table is stored in non-volatile semiconductor memory.

13. The system according to claim 8, wherein said data sector information table is stored on said magneto-optical data storage disk.

14. The system according to claim 8, wherein the data sector information table is calculated from format parameters stored on said data storage disk, according to an algorithm stored on said data storage disk.

15. The system according to claim 8, wherein the data sector information table is calculated from format parameters stored on said data storage disk, according to an algorithm stored in non-volatile semiconductor memory.

16. A computer-readable storage medium having a configuration that represents data and instructions that cause a processor to:
read format information from non-volatile memory;
calculate from said format information the data indicative of the location of constituent portions of data sectors stored on a magneto-optical data storage disk;
store said data indicative of the location of constituent portions of data sectors in a data sector information table data sector information table in semiconductor memory;
access said data sector information table in response to a request for a specific target sector from interface electronics;
determine from said data sector information table the precise location of said target sector;
instruct actuator electronics to locate said target data sector on the surface of said magneto-optical data storage disk; and
return requested data from said target sector to said interface electronics.

17. The computer-readable storage medium of claim 16, wherein the configuration that represents data and instructions further causes a processor to verify the integrity of the data in said target sector by applying error correction information included in said data sector information table.

18. The computer-readable storage medium of claim 16, wherein the configuration that represents data and instructions further causes a processor to verify the integrity of the data in said target sector by applying error detection information included in said data sector information table.

19. A computer-readable storage medium having a configuration that represents data and instructions that cause a processor to:
read format information from non-volatile memory;
calculate from said format information the location of constituent portions of a target data sector stored on said disk;
instruct actuator electronics to locate constituent portions of said target data sector on the surface of said magneto-optical disk; and
return requested data from said target sector on said disk surface to said interface electronics.

20. The storage medium of claim 19, wherein the configuration that represents data and instructions further causes a processor to:
read format information from a data storage disk; and
store the format information in random-access memory.
